(19) United States
(12) Patent Application Publication
(10) Pub. No.: US 2008/0313390 A1
(43) Pub. Date: Dec. 18, 2008

(54) Method and System for Presenting an Executing Status of a Memory Card

(75) Inventors: Tsai-Cheng Lin, Hsinchu City (TW); Yu-Chih Kuan, Taichung City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: Silicon Motion, Inc, Jhubei City (TW)

(21) Appl. No.: 12/013,501

(22) Filed: Jan. 14, 2008

Related U.S. Application Data
(60) Provisional application No. 60/943,642, filed on Jun. 13, 2007.

(51) Int. Cl. G06F 12/00

(52) U.S. Cl. 711/103; 711/115; 711/E12.001

(57) ABSTRACT

A system and a method for presenting an executing status of a memory card are provided. The system comprises a processing apparatus and an access device. The processing apparatus stores an application program having a plurality of icons. The access device connects the memory card and the processing apparatus. The processing apparatus sends a reading command to the memory card via the access device. The memory card sends executing information in reply after receiving the reading command. Finally, the processing apparatus analyzes the executing information of the memory card and presents a corresponding icon through the application program in association with the analytic result.

This application claims the benefit of Provisional Application Ser. No. 60/943,642 filed on Jun. 13, 2007.

### CROSS-REFERENCES TO RELATED APPLICATIONS

Not Applicable.

### BACKGROUND OF THE INVENTION

1. Field of the Invention

The present invention relates to a system and a method for presenting an executing status of a memory card; more specifically, the present invention relates to a system and a method for presenting an executing status of a memory card by the use of different icons.

2. Descriptions of the Related Art

Conventional data storage devices include hard discs, floppy discs, and more recently, memory cards. Each of these storage devices uses a specific method of storage. For example, a memory card utilizes flash memory to store data. As the capacity and utility of flash memory and other non-volatile memory are improving while maintaining reasonable price points, portable data storage devices containing flash memory remain popular. Examples included Compact Flash (CF) memory cards, Memory Stick (MS) cards, and Secure Digital (SD) cards, etc. Access devices for these flash memory-based devices include a variety of card readers, such as a CF card reader.

The status between the connection of a memory card and a computer via a corresponding access device is indicated by two kinds of icons that can be displayed by the operation system (OS) of the computer. One of the icons is a monochromatic icon to indicate that the memory card is not connected to the computer via the corresponding access device, and the other icon is a chromatic icon to indicate that the memory card is connected to the computer via the corresponding access device.

In recent years, the development of memory cards has progressed more and more rapidly, yielding many variations and specifications of memory cards. For example, the CF card can be connected to the computer through a PIO mode or an UDMA mode. Another example of these variations is the several types of MS cards, such as MS HG cards and MS pro cards. However, the OS of the computer of the present state only can display the two kinds of icons mentioned earlier to indicate if a memory card is connected to the computer. Consequently, there are no additional icons in the OS of the computer to indicate the different modes or specifications of the memory card.

Therefore users can only identify whether a memory card is connected to a computer or not based on the monochromatic icon and the chromatic icon. Accordingly, a method and a system for displaying not only the connecting statuses, but also the different executing statuses of a memory card through the use of additional icons are needed.

### SUMMARY OF THE INVENTION

An objective of this invention is to provide a method for presenting an executing status of a memory card that is connected to an access device. The method comprises the steps of: sending a reading command to the memory card via the access device; sending executing information from the memory card in reply; analyzing the executing information of the memory card; and presenting a corresponding icon through an application program in association with the analytic result.

Another objective of this invention is to provide a system, which comprises a processing apparatus and an access device, for presenting an executing status of a memory card. The processing apparatus stores an application program with a plurality of icons. The access device connects the memory card and the processing apparatus. The processing apparatus sends a reading command to the memory card via the access device. The memory card sends executing information in reply after receiving the reading command. Finally, the processing apparatus analyzes the executing information of the memory card and presents a corresponding icon through the application program in association with the analytic result.

Using this arrangement, the present invention is capable of presenting not only connecting statuses, but also different executing statuses of a memory card through the use of different icons. Users will then be able to identify more than the standard two connection statuses of a connected memory card.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a functional block diagram of a first embodiment of the present invention;

FIG. 2 is a flow chart illustrating a second embodiment of this invention;

FIG. 3 is a flow chart illustrating the second embodiment with the use of a MS card; and

FIG. 4 is a flow chart illustrating the second embodiment with the use of a MMC card.

### DESCRIPTION OF THE PREFERRED EMBODIMENT

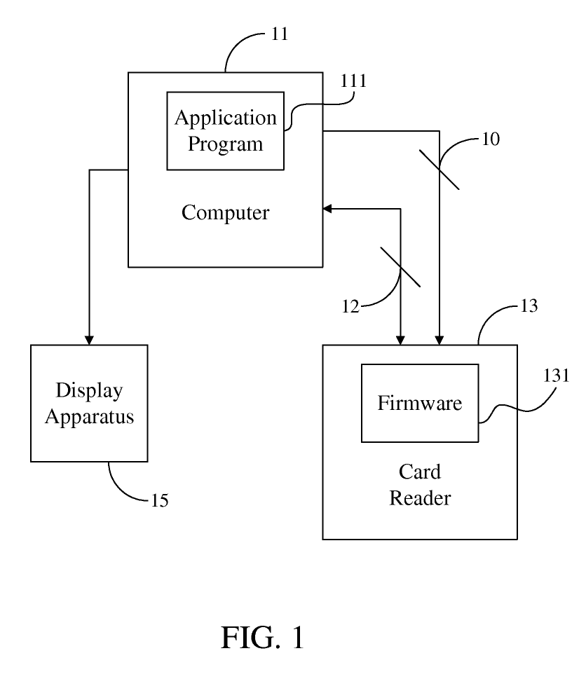

FIG. 1 illustrates a functional block diagram of a first embodiment of the present invention. The first embodiment utilizes an application program 111 in a processing apparatus, such as a computer 11 paired with an access device, such as a card reader 13 to connect a memory card (not shown), such as an MS card, a CF card, or a Multimedia card (MMC card), etc. With an appropriate firmware 131, the card reader 13 is connected to the computer 11 through a connection interface, such as an USB connection interface or an IEEE 1394 connection interface, etc. The application program 111 sends commands, such as a Vendor command 10, to the firmware 131 so that the firmware 131 can execute processes to read/write information 12 or data 12 from/to the memory card. A display apparatus 15 is connected to the computer 11 to present the executing status of the card reader 13 using monochromatic icons and chromatic icons.

The application program 111 will send the Vendor command 10 to the firmware 131 of the card reader 13 whenever it is predetermined to so do. After receiving the Vendor command 10, the card reader 13 sends information 12 about executing statuses of the card reader 13. In response to the information 12, the application program 111 determines whether or not the memory card is plugged into the card reader 13.

If there is no memory card plugged into the card reader 13, the application program 111 indicates a monochromatic icon for the display apparatus 15 to present. If the memory card is plugged into the card reader 13, the application program 111 analyzes the 16 byte card information 12 to further understand an executing status of the memory card plugged into card reader 13.

For example, if the memory card is an MS card, the application program 111 analyses the information 12 according to the different types of MS cards. The MS card can be subcategorized as a MS HG card, a MS pro duo card, or a MS pro card, etc. As another example, if the memory card is a MMC card, the application program 111 analyses the information 12 according to the different types of MMC cards. The MS card can be subcategorized as an 8 bit/50 MHz MMC card, an 8 bit/25 MHz MMC card, or a 4 bit/50 MHz MMC card, etc.

Finally, if the application program 111 has understood the executing status of the memory card through the appropriate information 12, the application program 111 chooses a corresponding chromatic icon which is stored in the application program 111 for the display apparatus 15 to present.

Beside the MS card or MMC card, the application program 111 can also analyze the information 12 according to the different types of CF cards, SD cards, xD cards, or any other memory cards that can store various data. Those skilled in the art can understand the corresponding operations through the above description, and thus, no unnecessary details are given further.

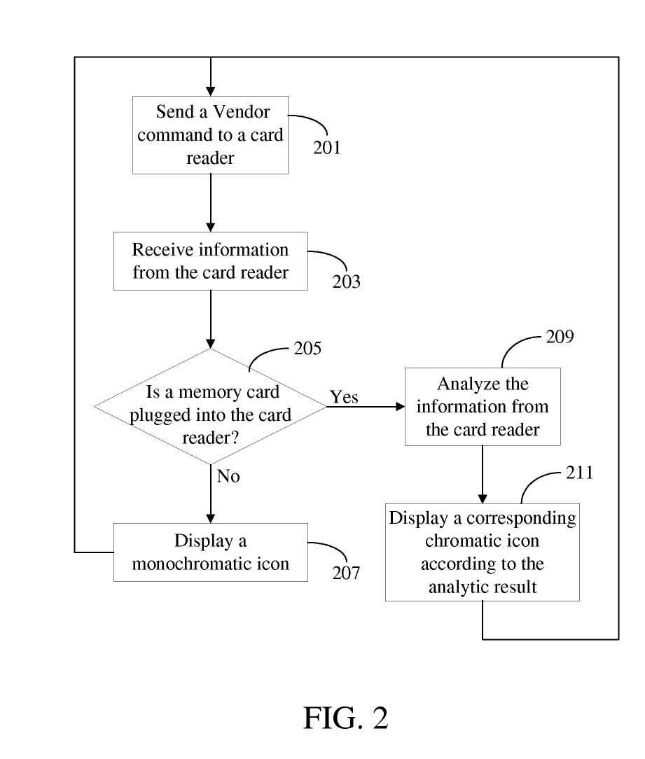

FIG. 2 illustrates a flow chart of a second embodiment. First, step 201 is executed for sending a Vendor command to a card reader. Next, step 203 is executed for receiving information from the card reader. Step 205 is executed to determine whether a memory card is plugged into the card reader or not. If not, step 207 is executed for presenting a monochromatic icon, which then returns to step 201 to send another Vendor command. If it is determined that the memory card is plugged into the card reader, step 209 is executed for analyzing the information sent from the card reader. Finally, step 211 is executed for presenting a corresponding chromatic icon according to the analytic result, which then returns to step 201 to send another Vendor command.

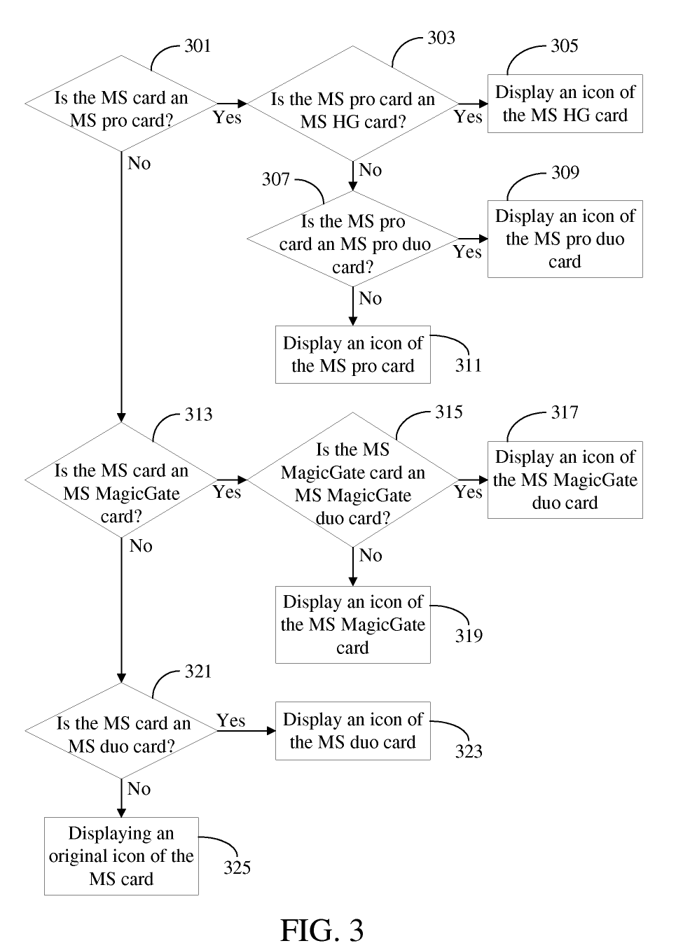

FIG. 3 illustrates a flow chart of step 209 and step 211 if the memory card is a MS card. Step 301 is executed to determine whether the MS card is a MS pro card. If so, step 303 is executed to determine whether the MS pro card is a MS HG card. If the MS pro card is determined to be a MS HG card, step 305 is executed for presenting an icon corresponding to the MS HG card. If the MS pro card is determined not to be a MS HG card in step 303, step 307 is executed to determine whether the MS pro card is a MS pro duo card. If the MS pro card is determined to be a MS pro duo card in step 307, step 309 is executed for presenting an icon corresponding to the MS pro duo card. If the MS pro card is determined not to be a MS pro duo card in step 307, step 311 is executed for presenting an icon of the MS pro card.

If the MS card is determined not to be a MS pro card in step 301, step 313 is executed to determine whether the MS card is a MS MagicGate card. If so, step 315 is executed to determine whether the MS MagicGate card is a MS MagicGate duo card. If the MS MagicGate card is determined to be a MS MagicGate duo card, step 317 is executed for presenting an icon corresponding to the MS MagicGate duo card. If the MS MagicGate card is determined not to be a MS MagicGate duo card, step 319 is executed for presenting an icon corresponding to the MS MagicGate card.

If the MS card is determined not to be a MS MagicGate card in step 313, step 321 is executed to determine whether the MS card is a MS duo card. If so, step 323 is executed for presenting an icon corresponding to the MS duo card. If not, step 323 is executed for presenting an original icon corresponding to the MS card.

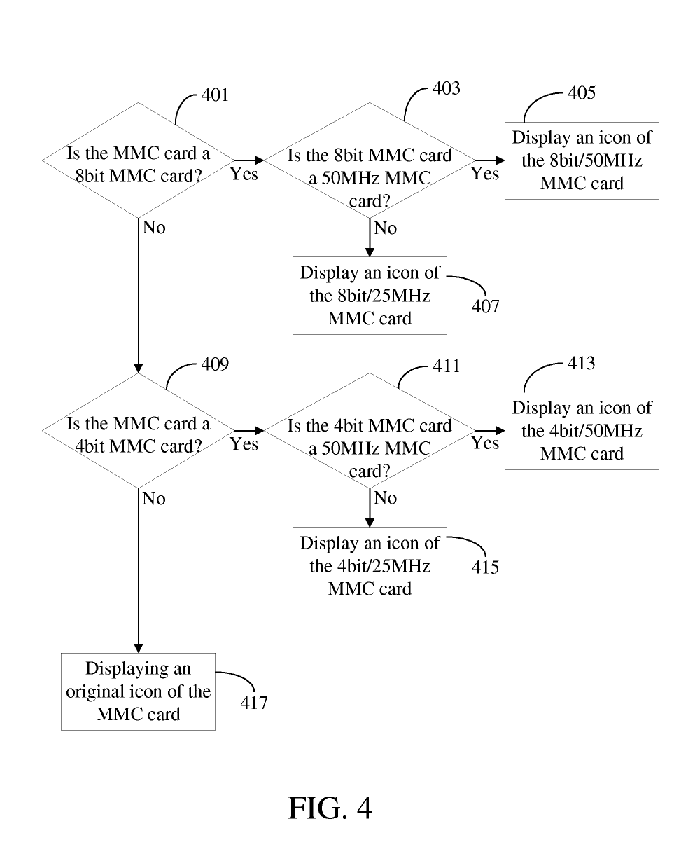

FIG. 4 illustrates another flow chart of step 209 and step 211 if the memory card is a MMC card. Step 401 is executed to determine whether the MMC card is an 8 bit MMC card. If so, step 403 is executed to determine whether the 8 bit MMC card is a 50 MHz MMC card. If the 8 bit MMC card is determined to be a 50 MHz MMC card, step 405 is executed for presenting an icon corresponding to the 8 bit/50 MHz MMC card. If the 8 bit MMC card is determined not to be a 50 MHz MMC card, step 407 is executed for presenting an icon of the 8 bit/25 MHz MMC card.

If the MMC card is determined not to be an 8 bit MMC card in step 401, step 409 is executed to determine whether the MMC card is a 4 bit MMC card. If so, step 411 is executed to determine whether the 4 bit MMC card is a 50 MHz MMC card. If the 4 bit MMC card is determined to be a 50 MHz MMC card, step 413 is executed for presenting an icon corresponding to the 4 bit/50 MHz MMC card. If the 4 bit MMC card is determined not to be a 50 MHz MMC card, step 415 is executed for presenting an icon corresponding to a 4 bit/25 MHz MMC card.

Finally, if the MMC card is determined not to be a 4 bit MMC card in step 409, step 417 is executed for presenting an original icon corresponding to the MMC card.

In addition to the operations depicted in the second embodiment as shown in FIG. 2, the second embodiment can also execute all the operations of the first embodiment. Beside the MS card or MMC card, the second embodiment of the present invention can also analyze the information according to the different types of CF cards, SD cards, xD cards, or any other memory cards that can store various data. Those skilled in the art can understand the corresponding steps or operations of the second embodiment through the first embodiment, and thus, no unnecessary details are given further.

Accordingly, the present invention is capable of presenting not only the connecting statuses but also different executing statuses of a memory card through the use of different icons. As a result, users are able to identify more than the standard two connection statuses of a connected memory card.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for presenting an executing status of a memory card connected to an access device, comprising the steps of:
sending a reading command to the memory card via the access device;
sending executing information from the memory card in reply;
analyzing the executing information of the memory card; and
presenting a corresponding icon through an application program in association with the analytic result.

2. The method as claimed in claim 1, the analyzing step further comprising a step of:
identifying a transmitting mode of the memory card.

3. The method as claimed in claim 1, the analyzing step further comprising a step of:
identifying an operating frequency of the memory card.

4. The method as claimed in claim 1, the analyzing step further comprising a step of:
identifying a data bus type of the memory card.

5. A system for presenting an executing status of a memory card, comprising:
a processing apparatus for storing an application program with a plurality of icons; and
an access device for connecting the memory card and the computer;
wherein the processing apparatus sends a reading command to the memory card via the access device, the memory card sends executing information after receiving the reading command, the processing apparatus analyzes the executing information of the memory card and presents a corresponding icon through the application program in association with the analytic result.

6. The system as claimed in claim 5, wherein the access device comprises a firmware, and the processing apparatus identifies a transmitting mode of the memory card via the firmware of the access device.

7. The system as claimed in claim 5, wherein the access device comprises a firmware, and the processing apparatus identifies an operating frequency of the memory card via the firmware of the access device.

8. The system as claimed in claim 5, wherein the access device comprises a firmware, and the processing apparatus identifies a data bus type of the memory card via the firmware of the access device.

9. The system as claimed in claim 5, wherein the corresponding icon is chromatic.

10. The system as claimed in claim 5, wherein the memory card is one of a Compact Flash (CF) memory card, a Memory Stick (MS) card, and a Secure Digital (SD) card.
